(19) United States
(12) Patent Application Publication
(10) Pub. No.: US 2005/0120525 A1
(43) Pub. Date: Jun. 9, 2005

(54) Cremation remains container system and method of memorializing deceased with same

(76) Inventors: Tom Heil, Batesville, IN (US); Chris Lowery, Batesville, IN (US); Christopher M. Wessel, Batesville, IN (US)

Correspondence Address: WOOD, HERRON & EVANS, LLP, 2700 CAREW TOWER, 441 VINE STREET, CINCINNATI, OH, 45202, US

(21) Appl. No.: 10/730,838

(22) Filed: Dec. 9, 2003

(51) Int. Cl. A61G 17/00

(52) U.S. Cl. 27/1

(57) ABSTRACT

A method of memorializing a deceased comprises providing a common base, the base including a cremation remains compartment therein and being adapted to have secured thereto a figurine; providing a plurality of figurines, the figurines adapted to be interchangeably secured to the common base; selecting one figurine from the plurality of figurines for securement to the common base; securing the selected figurine to the common base; and placing cremation remains of the deceased in the cremation remains compartment of the common base. A cremation remains container system comprises a common base, the base including a cremation remains compartment therein and being adapted to have secured thereto a figurine; and a plurality of figurines, the plurality of figurines adapted to be interchangeably secured to the common base; whereby one can select one figurine from the plurality of figurines, secure the one figurine to the common base and place cremation remains of a deceased in the cremation remains compartment of the common base to memorialize the deceased.

### FIELD OF THE INVENTION

This invention relates generally to the funeral industry, and more particularly to the cremation segment of the funeral industry.

### BACKGROUND OF THE INVENTION

Cremation is a growing segment of the funeral industry. Consequently, there is an increasing demand for more and higher quality styles and designs of cremation remains containers. To that end the assignee of the present invention has responded with new and innovative cremation remains containers which are sculptural works of art. Examples of such sculptural artwork cremation remains containers which the assignee of the present invention has introduced to the industry are disclosed in U.S. Design Pat. Nos. D401,732 and D401,733, hereby incorporated by reference herein. In the cremation remains containers of these patents, the cremation remains compartment is integrally formed in the sculpture.

Many casket manufacturers and funeral directors now manufacture and offer many “custom modular” variations of caskets, rather than selling mere “cookie cutter” or “one size fits all” caskets, thereby allowing the loved one to in essence design a specific casket especially suited or tailored to the deceased. For example, customers can select from a number of casket materials, casket finishes, casket corner adornments and casket interiors. Advances made in the area of “quick change” and “tool less” fastening mechanisms have greatly facilitated the rapid removal of one accessory from the casket and the rapid installation of another more desirable accessory to the casket. In addition to promoting personalization of the casket to the deceased, such interchangeability greatly reduces the amount of inventory the funeral director must keep on hand. An example may be seen in the assignee's U.S. Pat. No. 6,591,466 titled Quick Change Casket Comer Attachment Mechanism and hereby incorporated by reference herein, commercially available as the LifeSymbols® line of interchangeable corner adornments available from Batesville®.

It is desirable to apply the techniques of casket manufacture, allowing the loved one to in essence design a specific casket especially suited or tailored to the deceased, to the manufacture of cremation remains containers.

### SUMMARY OF THE INVENTION

The present invention is a method of memorializing a deceased comprising providing a common base, the base including a cremation remains compartment therein and being adapted to have secured thereto a figurine; providing a plurality of figurines, the figurines adapted to be interchangeably secured to the common base; selecting one figurine from the plurality of figurines for securement to the common base; securing the selected figurine to the common base; and placing cremation remains of the deceased in the cremation remains compartment of the common base.

In another aspect, a cremation remains container system comprises a common base, the base including a cremation remains compartment therein and being adapted to have secured thereto a figurine; and a plurality of figurines, the plurality of figurines adapted to be interchangeably secured to the common base; whereby one can select one figurine from the plurality of figurines, secure the one figurine to the common base and place cremation remains of a deceased in the cremation remains compartment of the common base to memorialize the deceased.

The base can include an opening in a bottom thereof communicating with the compartment, and a cover securable over the opening for securing the cremation remains in the compartment. The cover can be recessed so as to be flush with the bottom of the base. The cover can be secured to the base via fasteners. The fasteners can be screws. The base and the plurality of figurines can include mating fasteners for securing one to another. The base can include a threaded post on a top thereof and the plurality of figurines can include a matingly threaded recess in a bottom thereof.

In yet another aspect, a method for a funeral products manufacturer of producing and distributing cremation remains containers comprises providing a common base, the base including a cremation remains compartment therein and being adapted to have secured thereto a figurine; providing a plurality of figurines, the plurality of figurines adapted to be interchangeably secured to the common base; selecting a figurine from the plurality of figurines; securing the selected figurine to the common base; and shipping cremation remains container to a funeral director.

The funeral products manufacturer can either manufacture or purchase the base and figurines.

Unlike the cremation remains containers disclosed in the assignee's U.S. Design Pat. Nos. D401,732 and D401,733, the cremation remains compartment of the cremation remains container of the present invention is not integrally formed in/with the sculpture/figurine. Rather, a plurality of sculptures/figurines are provided from which a customer may choose; the sculptures are interchangeably securable to a single, common base, which single, common base includes the cremation remains compartment. A funeral director thus need only stock the single, common base. In this manner, the principle of interchangeability reducing the amount of casket inventory the funeral director must keep on hand, as seen in the assignee's U.S. Pat. No. 6,591,466 titled Quick Change Casket Comer Attachment Mechanism and commercially available as the LifeSymbols® line of interchangeable corner adornments from Batesville®, is applied to cremation products.

These and other features and advantages of the present invention will become more readily apparent during the following detailed description taken in conjunction with the drawings herein, in which:

### BRIEF DESCRIPTION OF THE DRAWINGS OF THE INVENTION

FIG. 1 is a perspective view of the cremation remains container of the present invention;

FIG. 2 is view similar to FIG. 1 with the figurine of the cremation remains container detached from the base of the cremation remains container;

FIG. 3 is a cross-sectional view of the base of the cremation remains container taken along line 3-3 of FIG. 2; and

FIG. 4 is a perspective view of another figurine securable to the base of FIGS. 1-3.

### DETAILED DESCRIPTION OF THE INVENTION

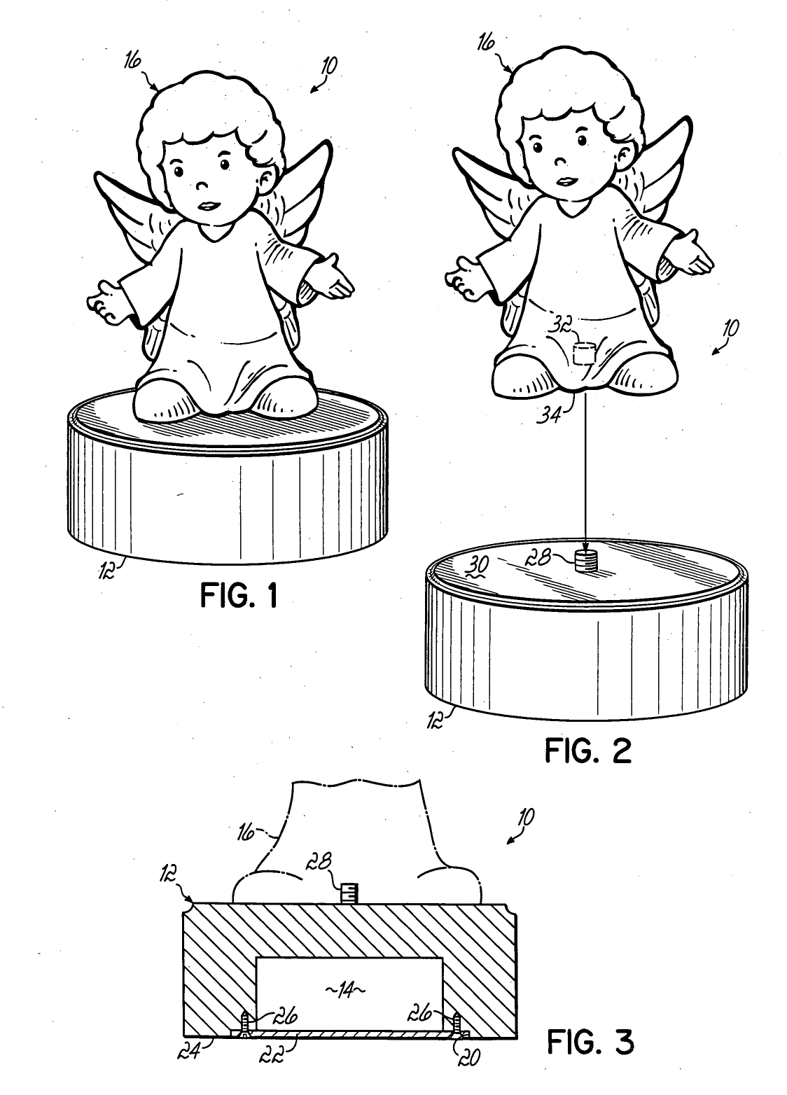

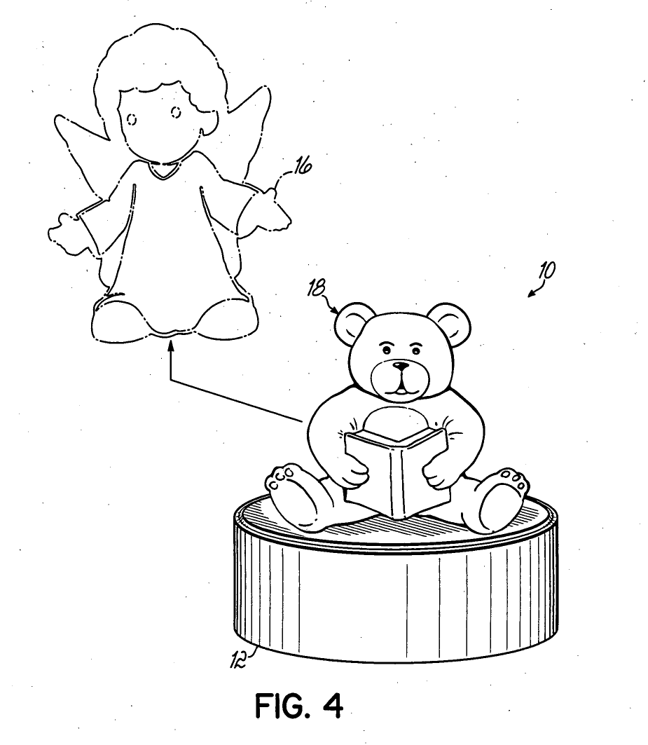

Referring to FIGS. 1-4, there is illustrated a cremation remains container system 10 according to the principles of the present invention. The foundation of the system 10 is a single, common base 12. The base 12 includes a cremation remains compartment 14 therein. The base 12 is also adapted to have secured thereto a figurine and/or sculpture, such as that denoted by 16 in FIGS. 1 and 2 or 18 in FIG. 4. It is contemplated that the system 10 would include a plurality of different figurines, with each of the plurality adapted to be interchangeably secured to the common base 12; in that manner, one can select one figurine from amongst the plurality of figurines, secure the one figurine to the common base 12 and place cremation remains of a deceased in the cremation remains compartment 14 of the common base 12 to memorialize the deceased.

The base 12 can include an opening 20 in a bottom thereof communicating with the cremation remains compartment 14, and a cover 22 securable over the opening 20 for securing the cremation remains in the compartment 14. The cover 22 can be recessed so as to be flush with the bottom 24 of the base 12. The cover 22 can be secured to the base 12 via fasteners, for example screws 26. The base 12 and the plurality of figurines 16, 18 can include mating fasteners for securing one to another, for example, the base 12 can include a threaded post 28 on a top 30 thereof and the plurality of figurines 16, 18 can include a matingly threaded recess 32 in a bottom 34 thereof. Other fasteners such as adhesives, double-sided tape, hook and loop, etc. can be employed.

In one possible manner of use, a funeral director can provide the customer with the common base, and with a plurality of figurines, each interchangeably securable to the common base, from which to choose. The customer can select one of the figurines and the funeral director can secure the selected figurine to the common base. The funeral director can place the cremation remains of the deceased in the cremation remains compartment of the common base and present the assembled cremation remains container with cremation remains therein to the surviving loved one. In another possible manner of use, a funeral products manufacturer can manufacture and/or purchase a single, common base along with a plurality of figurines. Depending on demand, the manufacturer can assemble the figurine(s) in demand with the common base and ship them to funeral directors.

Those skilled in the art will readily recognize numerous adaptations and modifications which can be made to the present invention which will result in an improved cremation remains container, yet all of which will fall within the spirit and scope of the present invention as defined in the following claims. Accordingly, the invention is to be limited only by the scope of the following claims and their equivalents.

1. A method of memorializing a deceased comprising:
providing a common base, the base including a cremation remains compartment therein and being adapted to have secured thereto a figurine;
providing a plurality of figurines, the figurines adapted to be interchangeably secured to the common base;
selecting one figurine from the plurality of figurines for securement to the common base;
securing the selected figurine to the common base; and
placing cremation remains of the deceased in the cremation remains compartment of the common base.

2. A cremation remains container system comprising:
a common base, said base including a cremation remains compartment therein and being adapted to have secured thereto a figurine; and
a plurality of figurines, said plurality of figurines adapted to be interchangeably secured to said common base;
whereby one can select one figurine from said plurality of figurines, secure said one figurine to said common base and place cremation remains of a deceased in said cremation remains compartment of said common base to memorialize the deceased.

3. The cremation remains container system of claim 2 wherein said base includes an opening in a bottom thereof communicating with said compartment, and a cover securable over said opening for securing the cremation remains in said compartment.

4. The cremation remains container system of claim 3 wherein said cover is recessed so as to be flush with said bottom of said base.

5. The cremation remains container system of claim 3 wherein said cover is secured to said base via fasteners.

6. The cremation remains container system of claim 5 wherein said fasteners are screws.

7. The cremation remains container system of claim 2 wherein said base and said plurality of figurines include mating fasteners for securing one to another.

8. The cremation remains container system of claim 7 wherein said base includes a threaded post on a top thereof and said plurality of figurines include a matingly threaded recess in a bottom thereof.

9. A method for a funeral products manufacturer of producing and distributing cremation remains containers comprising:
providing a common base, the base including a cremation remains compartment therein and being adapted to have secured thereto a figurine;
providing a plurality of figurines, the plurality of figurines adapted to be interchangeably secured to the common base;
selecting a figurine from the plurality of figurines;
securing the selected figurine to the common base; and
shipping cremation remains container to a funeral director.

10. The method of claim 9 wherein the funeral products manufacturer manufactures the base in house.

11. The method of claim 9 wherein the funeral products manufacturer purchases the base.

12. The method of claim 9 wherein the funeral products manufacturer manufactures the figurines.

13. The method of claim 9 wherein the funeral products manufacturer purchases the figurines.
